(19) United States
(12) Patent Application Publication
(10) Pub. No.: US 2019/0138111 A1
(43) Pub. Date: May 9, 2019

(54) ILLUMINATED KEYBOARD

(71) Applicant: Shih-Pin Lin, Taichung City (TW)

(72) Inventor: Shih-Pin Lin, Taichung City (TW)

(73) Assignee: Sunrex Technology Corp., Taichung City (TW)

(21) Appl. No.: 15/802,456

(22) Filed: Nov. 3, 2017

(51) Int. Cl. G06F 3/02; H01H 13/83

(52) U.S. Cl. CPC G06F 3/0219; H01H 2219/014; H01H 13/83

(57) ABSTRACT

An illuminated keyboard is provided with a plurality of key caps, a plurality of bridge structures, a plurality of hollow, resilient domes, a frame board, a membrane circuit board, a reflective layer, and a light transmissive membrane including a plurality of light-emitting diodes (LEDs), printed circuits, and a plurality of recesses. The key caps are uniformly illuminated.

### BACKGROUND OF THE INVENTION

### 1. Field of the Invention

The invention relates to computer keyboards and more particularly to an illuminated keyboard having improved characteristics including uniform light impinged toward the keys.

### 2. Description of Related Art

Laptops are popular due to portability and the Internet access. Typically, a bridge structure is provided between each key cap and a base board. However, there is no provision of backlight. Thus, it is inconvenient to use the laptop in a dark environment because the key caps are not illuminated.

Taiwan Utility Model Number M306689 discloses an illuminated keyboard. It has the following drawback: Keys distal the LEDs are not sufficiently lit due to no light intensity adjustment and/or increase arrangement.

Thus, the need for improvement still exists.

### SUMMARY OF THE INVENTION

It is therefore one object of the invention to provide an illuminated keyboard comprising a light transmissive membrane including a plurality of light-emitting diodes (LEDs), printed circuits, and a plurality of recesses.

The above and other objects, features and advantages of the invention will become apparent from the following detailed description taken with the accompanying drawings.

### BRIEF DESCRIPTION OF THE DRAWINGS

FIG. 1 is an exploded perspective view of an illuminated keyboard according to a first preferred embodiment of the invention;

FIG. 2 is an exploded view of FIG. 1;

FIG. 3 is a longitudinal sectional view of the assembled components of FIG. 2;

FIG. 4 is an exploded view of an illuminated keyboard according to a second preferred embodiment of the invention; and

FIG. 5 is a longitudinal sectional view of the assembled components of FIG. 4.

### DETAILED DESCRIPTION OF THE INVENTION

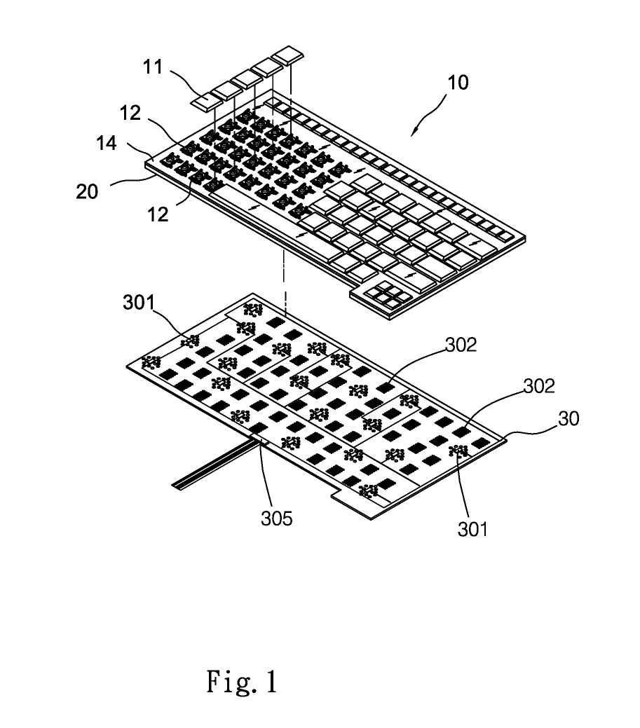

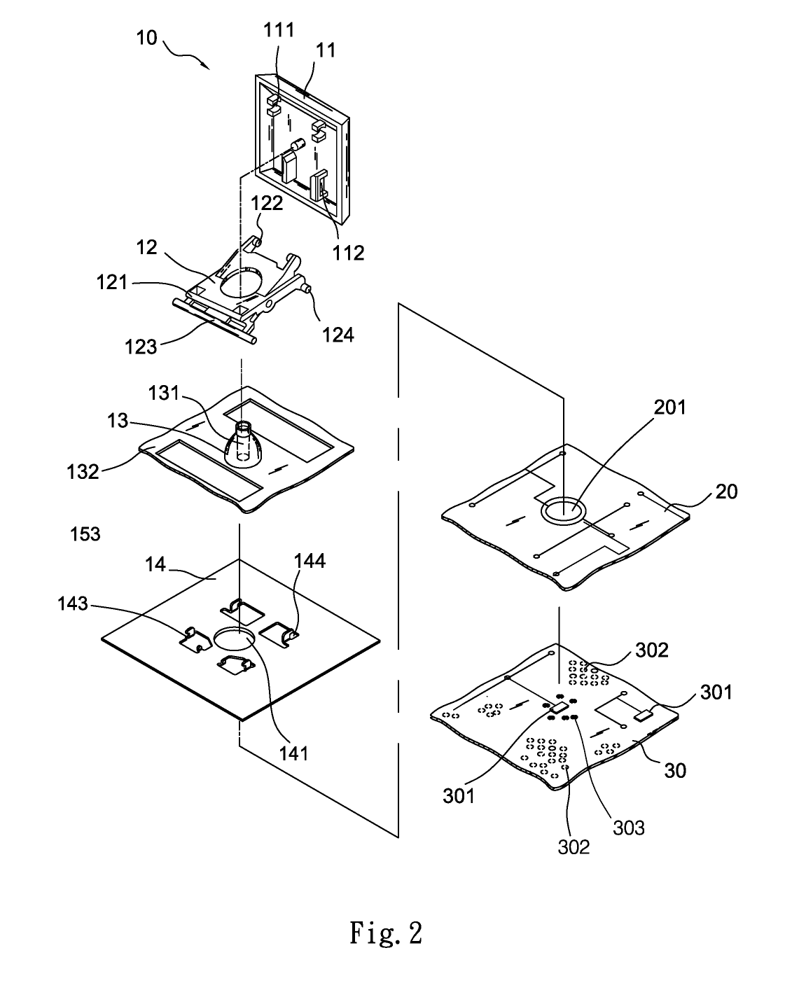

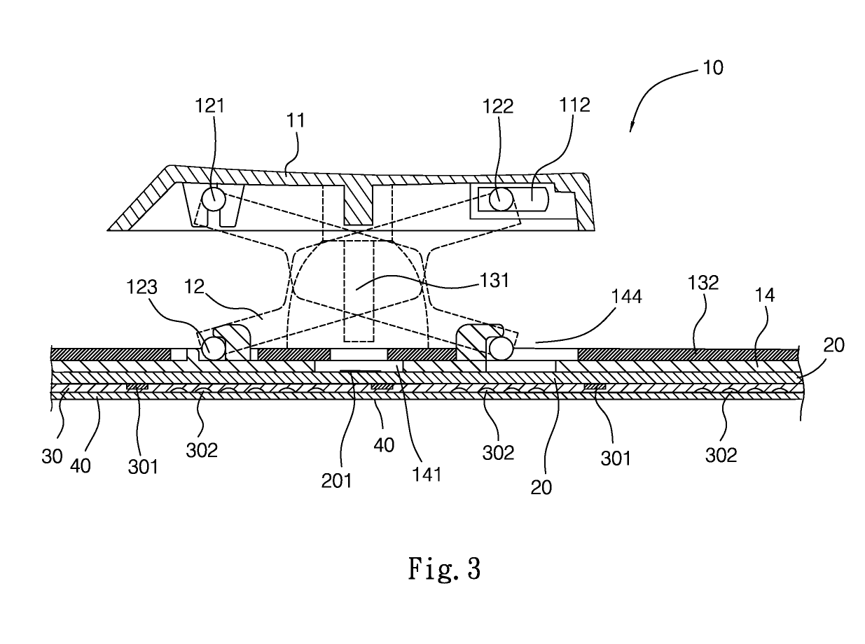

Referring to FIGS. 1 to 3, an illuminated keyboard 10 in accordance with a first preferred embodiment of the invention comprises the following components as discussed in detail below.

The keyboard 10 comprises, from top to bottom, a plurality of key caps 11, a plurality of bridge structures 12, a plurality of hollow, resilient domes 13, a frame board 14, a membrane circuit board 20, a light transmissive membrane 30, and a reflective layer 40. Each component is discussed in detail below. Each key cap 11 is a square or rectangle, and is adapted to be depressed. The key caps 11 are transparent and each key cap 11 on its underside has two spaced troughs 111 proximate one edge and two spaced guide grooves 112 proximate the other edge.

The dome 13 includes a longitudinal central hole 131 and the domes 13 are provided on a membrane member 132. The dome 13 is disposed through the bridge structure 12 to secure to a bottom of the key cap 11. The frame board 14 includes a plurality of units each having a central hole 141 with the dome 13 disposed thereon, two spaced first snapping grooves 143 and two spaced second snapping grooves 144.

The bridge structure 12 includes a hollow, rectangular first member (not numbered) and a hollow, rectangular second member (not numbered) pivotably secured to the first member. The first member has two pivots 124 at two corners respectively and pivotably fastened in the second snapping grooves 144 respectively, and a pivot shaft 121 at one end and pivotably fastened in the troughs 111. The second member has two pivots 122 at two corners and pivotably mounted in the guide grooves 12 respectively, and a pivot shaft 123 at on end and pivotably fastened in the first snapping grooves 143. Thus, the bridge structure 12 is adapted to pivot between the key cap 11 and the frame board 14, thereby forming a bridge type press button structure.

The membrane circuit board 20 includes a plurality of central holes 201 each aligned with the central hole 141. The light transmissive membrane 30 is made of transparent plastic and includes a plurality of light-emitting diodes (LEDs) 301 and printed circuits electrically connected to a bus 305. The light transmissive membrane 30 further comprises a plurality of recesses 302 in which the recesses 203 distal the LEDs 301 have a greater depth and the recesses 203 proximate the LEDs 301 have a less depth so that a uniform light can be impinged toward the key cap 11. Further, a plurality of ink points 303 are provided around the LED 301 under the central hole 201 so that light emitted by the LEDs 301 can be directed to the underside of the key cap 11. The provision of the reflective layer 40 can give an increased light guide effect.

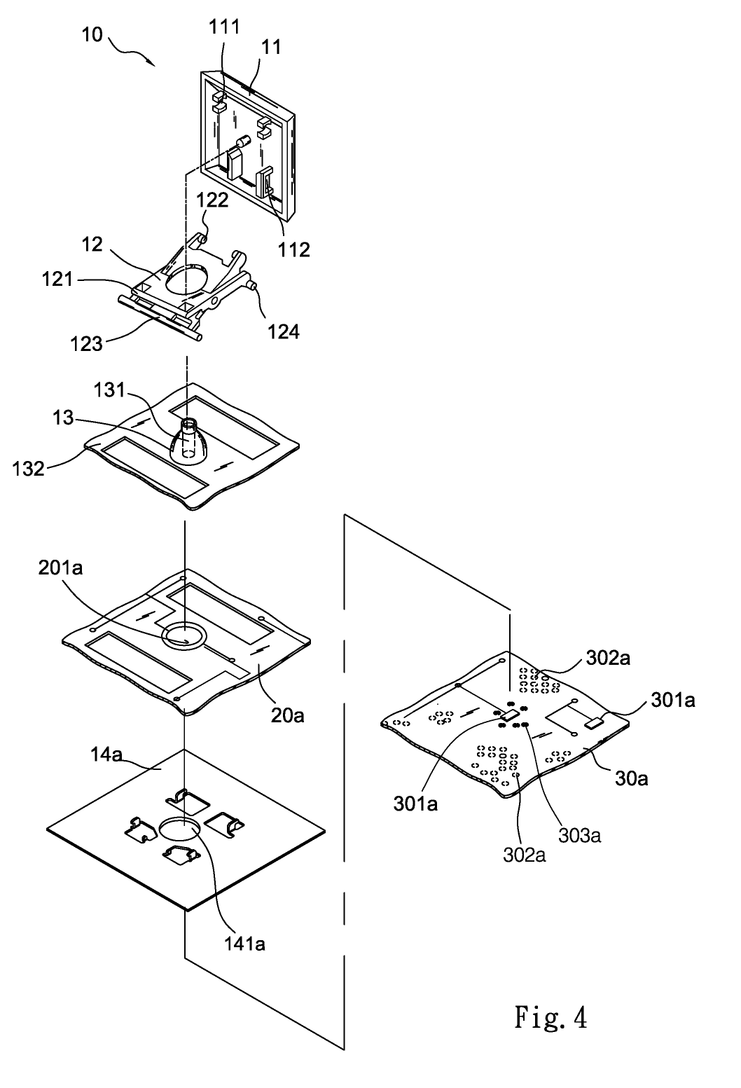

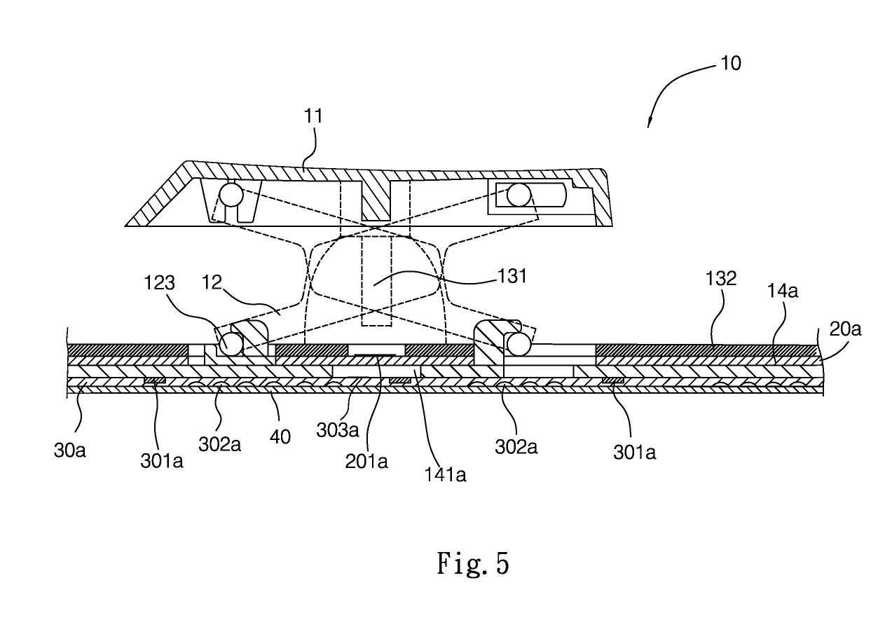

Referring to FIGS. 4 and 5, an illuminated keyboard in accordance with a second preferred embodiment of the invention is shown. The characteristics of the second preferred embodiment are substantially the same as that of the first preferred embodiment except the following:

The membrane circuit board 20a is provided between the membrane member 132 and the frame board 14a. The hole 201a of the membrane circuit board 20a is aligned with the hole 141a of the frame board 14a. The light transmissive membrane 30a includes a plurality of LEDs 301a, a plurality of recesses 302s, and a plurality of ink points 303a around the LED 301a under the central hole 141a so that light emitted by the LEDs 301a can be directed to the underside of the key cap 11.

While the invention has been described in terms of preferred embodiments, those skilled in the art will recognize that the invention can be practiced with modifications within the spirit and scope of the appended claims.

What is claimed is:

1. An illuminated keyboard comprising a light transmissive membrane including a plurality of light-emitting diodes (LEDs), printed circuits, and a plurality of recesses.

2. The illuminated keyboard of claim 1, further comprising, from top to bottom, a plurality of key caps, a plurality of bridge structures, a plurality of hollow, resilient domes, a frame board, and a membrane circuit board.

3. The illuminated keyboard of claim 2, wherein each key cap is transparent, is shaped as a square, and is adapted to be depressed, each key cap on its underside has two spaced troughs proximate one edge and two spaced guide grooves proximate the other edge; the domes are provided on a membrane member, each dome disposed through the bridge structure to secure to a bottom of the key cap and including a longitudinal central hole; and the frame board is disposed under the membrane member.

4. The illuminated keyboard of claim 2, wherein the light transmissive membrane is disposed under the membrane circuit board and formed of transparent plastic.

5. The illuminated keyboard of claim 2, wherein the plurality of recesses of the light transmissive membrane distal the LEDs have a greater depth, and the plurality of recesses of the light transmissive membrane proximate the LEDs have a less depth so that a uniform light can be impinged toward the key caps.

6. The illuminated keyboard of claim 1, wherein the light transmissive membrane further comprises a plurality of ink points provided around the LED under a hole of the membrane circuit board, further comprising a reflective layer under the membrane circuit board.

7. The illuminated keyboard of claim 1, further comprising, from top to bottom, a plurality of key caps, a plurality of bridge structures, a plurality of hollow, resilient domes, a membrane circuit board, and a frame board.

8. The illuminated keyboard of claim 7, wherein each key cap is transparent, is shaped as a square, and is adapted to be depressed, each key cap on its underside has two spaced troughs proximate one edge and two spaced guide grooves proximate the other edge; the domes are provided on a membrane member, each dome disposed through the bridge structure to secure to a bottom of the key cap and including a longitudinal central hole; and the frame board is disposed under the membrane member.

9. The illuminated keyboard of claim 7, wherein the light transmissive membrane is disposed under the membrane circuit board and formed of transparent plastic.

10. The illuminated keyboard of claim 7, wherein the plurality of recesses of the light transmissive membrane distal the LEDs have a greater depth, and the plurality of recesses of the light transmissive membrane proximate the LEDs have a less depth so that a uniform light can be impinged toward the key caps.
